(19) United States
(12) Patent Application Publication
(10) Pub. No.: US 2008/0106598 A1
(43) Pub. Date: May 8, 2008

(54) REMOTE ACCESS MEMORIAL VIEWING SYSTEM

(76) Inventor: DAVE SILVA, BOISE, ID (US)

Correspondence Address: DYKAS, SHAVER & NIPPER, LLP, P.O. BOX 877, BOISE, ID, 83701-0877, US

(21) Appl. No.: 11/557,182

(22) Filed: Nov. 7, 2006

(51) Int. Cl. H04N 7/18

(52) U.S. Cl. 348/143; 348/E07.084

(57) ABSTRACT

A system for allowing remote viewing of a particularized item located within a plurality of items; such as a particular gravesite within a cemetery. In particular the present system includes at least one viewing device, which is operatively connected to a host control device. This combination of items is configured and capable of capturing pictures from a designated location, when activated by a host control device and transmitting a signal carrying particular images from this preselected destination to a designated remote location. The access, images and distribution of these images all operated under the control of the host control device.

### FIELD OF THE INVENTION

This invention generally relates to memorials such as forestaries and cemeteries and more particularly to providing a viewing service to the friends, relatives and acquaintances of the individuals interred within such locations.

### SUMMARY OF THE INVENTION

The present invention is a system for allowing remote viewing of a particularized item located within a plurality of items; such as a particular gravesite within a cemetery, or a particular tree within a memorial grove or forestary. In particular the present system includes at least one viewing device positioned within such a location. This viewing device is operatively connected to a host control device. Within the host control device a map of the entire area is stored. Each individual plot, tree, or other designated location within the entire area is plotted on the map. When activated, the system is capable of activating the viewing device to capture and transmit images of a particularized pre-selected location to a designated remote receiving device. The access, gathering and distribution of these images all operated under the control of the host control device.

In the preferred embodiment of the invention, the viewing device is a remote operated web camera that is positioned in a pre-selected location and is capable of being moved into and out of a variety of positions. In some particular situations, a plurality of such viewing devices may be utilized to allow for the desired levels of coverage in a particularized location. In some circumstances, various images may be transmitted and displayed on a particular display device while under the control of the host control device.

In the preferred embodiment of the invention, the host control device is able to perform a variety of functions, and includes a variety of features. In one embodiment of the invention these functions include an embodiment where the entry of an appropriate password link causes the viewing device to go to a location wherein a particular item is displayed and for images from this location to be transmitted. This feature is enabled by the linking of a particularized password to particular location within a predefined map, which is included within and operatively connected to, the command hierarchy that is located in the host control device.

The command hierarchy includes a system of signals, which prompt a particular response once a desired and designated input has taken place. These desired inputs may include a variety of types and varieties of information that are related to the account to which the password is linked. Depending upon the particular embodiment of the invention, this may include various types of information related to information such as: the names of the parties, the location of the sites that are to be viewed, the type and level of subscription and other similar information.

Upon the input of these items into the system, the command hierarchy will engage in a variety of activities including directing a particular viewing device to capture an image from a pre-designated location, that is affiliated with this account and transmit this image to a distant location. In addition, the command hierarchy may allow viewing of other sites by preprogrammed selection or allow active or limited control movements over the camera device itself. Depending upon the exact configuration of the invention these items may take place by including various items such as the input of a designated authorization code or other similar actions. Such active control movements allow the remote operated web camera or similar viewing device to scroll or pan over and through a designated area. In some embodiments of the invention, the host controller displays the images through a graphic user interface which may also be utilized to allow the purchase of ancillary services such as flower delivery, gravesite maintenance or other actions.

Preferably, the function of this system is made possible by the interconnection and communication of the images and the inputs occurring through a computer-based network such as the World Wide Web. However, depending upon circumstances, other systems, devices and features may also be utilized. Depending upon the exact necessities of the user, this graphic user interface and the methods of transmitting, receiving and displaying moving images from one location to another may also be modified.

In such a system, the present invention is utilized by mapping a cemetery or memorial area so as to provide a map of particularized plots; assigning each of these particularized plots with a particular identifier; linking each of these particular identifiers with a user name and password; creating a command hierarchy wherein a user name and password is received through an inputting media; matching the user name and password to a particular identifier; commanding the remote operated web cam to present an image of the particularized plot that is assigned to the particular identifier that matches the user name and password; and transmitting this image from said remote operated web cam through a communication media.

In addition to these basic features various modifications to this method and system of operation may also take place. These additional steps may include engaging in any of the following activities: providing an interface wherein parties may purchase additional services for said grave side such as flower delivery, landscaping, message delivery, and candle placement; providing access to remote viewing of other locations in side or outside of said cemetery; changing passwords based upon a preselected criteria; capturing an image on a particular date and time; storing said image in a designated location; allowing access to said stored image upon the providing of an appropriate name and password by a user. In addition to these additional steps and features other various modifications may also be made to the system according to the needs and necessities of the user.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a perspective view of the system of the present invention.

FIG. 2 is a detailed planned view of the graphical user interface in the present invention.

FIG. 3 is a flow chart of method steps involved in the present invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

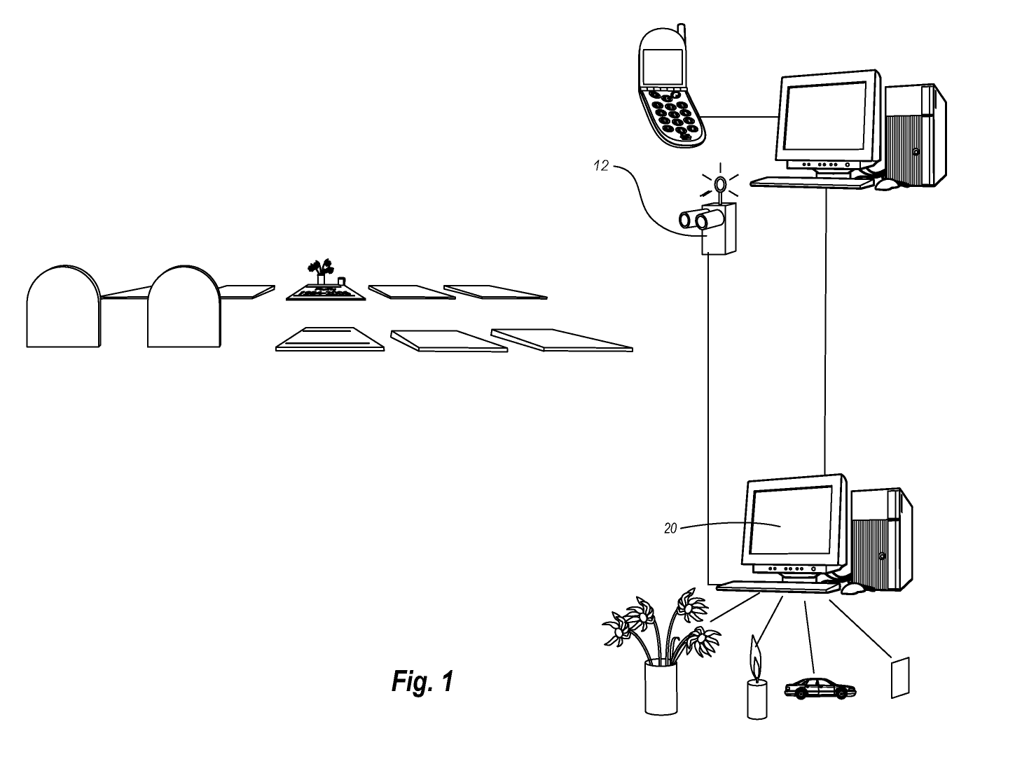

The present invention is a system and method for providing a variety of services to persons at a remote location from where a loved one is interred. FIGS. 1-3 show a variety of views of the system and methods involved in the present invention. While these particular embodiments of the invention are shown it is to be distinctly understood that the invention is not limited thereto but may be variously embodied according to the needs and necessities of a user.

Referring now to FIG. 1, the system of the present invention is shown. The present invention 10 is shown positioned within a memorial location that contains both a cemetery (made up of a plurality of grave markers such as headstones, foot stones, or other markers that denote the location of the grave of a particular individual) as well as forestary or memorial grove where the remains of a particular individual are interred beneath a particular tree. While the present invention is shown as a system located within this particular embodiment, it is to be distinctly understood that the invention is not limited thereto but may be variously embodied so as to fit a particular need in a variety of other positions and locations. This includes but is not limited to mausoleums, memorial monuments, and other situations where a particular object is located within a field of other objects.

The present invention is made up of at least one viewing device 12, which is positioned at a location within a designated area so as to be able to provide preselected and designated views of a variety of locations within the designated area. In the example, which is shown in FIG. 1, the viewing device 12 is positioned within a cemetery, preferably in a location where all of the gravesites are accessible and viewable. In other embodiments of the invention, a plurality of viewing devices 12 may be positioned in various locations all over the cemetery. Each of these various viewing devices is operatively connected to the host control device 14.

This host control device 14 contains a command hierarchy that is configured to receive input from a user, who is typically in a remote location and to select an appropriate viewing device 12 to capture an image of the particular location. The remote user connects to the system through any of a variety of connection devices or methods including direct cable wiring, infrared, wireless communications or any other type of device that enables a connection between the host control device 14 and the remote user to take place.

In the preferred embodiment of the invention, the viewing device 12 includes at least one remote operated video camera, preferably a web based camera or web cam. This device is placed in a particular location within a cemetery and is configured so as to allow various portions of the cemetery to be viewed. Depending upon the particular circumstances regarding where the device is placed, the type, number and placement of these devices may be variously configured. In one embodiment of the invention this may be done by one camera which can be moved in a variety of directions so as to be able to view all of the desired and designated portions of the cemetery. However, in other embodiments of the invention several cameras may be used so as to allow for complete and desired levels of coverage throughout the cemetery. In other embodiments of the invention individual web cameras may be placed in position so as to be able to view each and every particular headstone or burial plot within the cemetery. The modifications of this basic system may be varied according to the needs and necessities of the user, as well as raising other factors related to costs and maneuverability on the part of the business owner.

The viewing device 12, which in this case is preferably a remote operated web cam, is operatively connected to a host device 14 and is configured to transmit information from the remote operated camera 12 to any of a variety of receiving devices 16. In some embodiments of the invention these receiving devices 16, may also be the source 18 from which input into the host system 14 is accomplished.

As is shown in the figures, a variety of devices may be used to provide input or receive transmissions from the host control device 14. It is envisioned that any device which has the ability to connect to the combination of computers commonly referred to as the World Wide Web or internet may be utilized. This includes but is not limited to cell phones, computers, so called smart phones, telephones and any other types of devices. It will also be recognized with various modifications other types of devices for viewing may also be utilized in the present system.

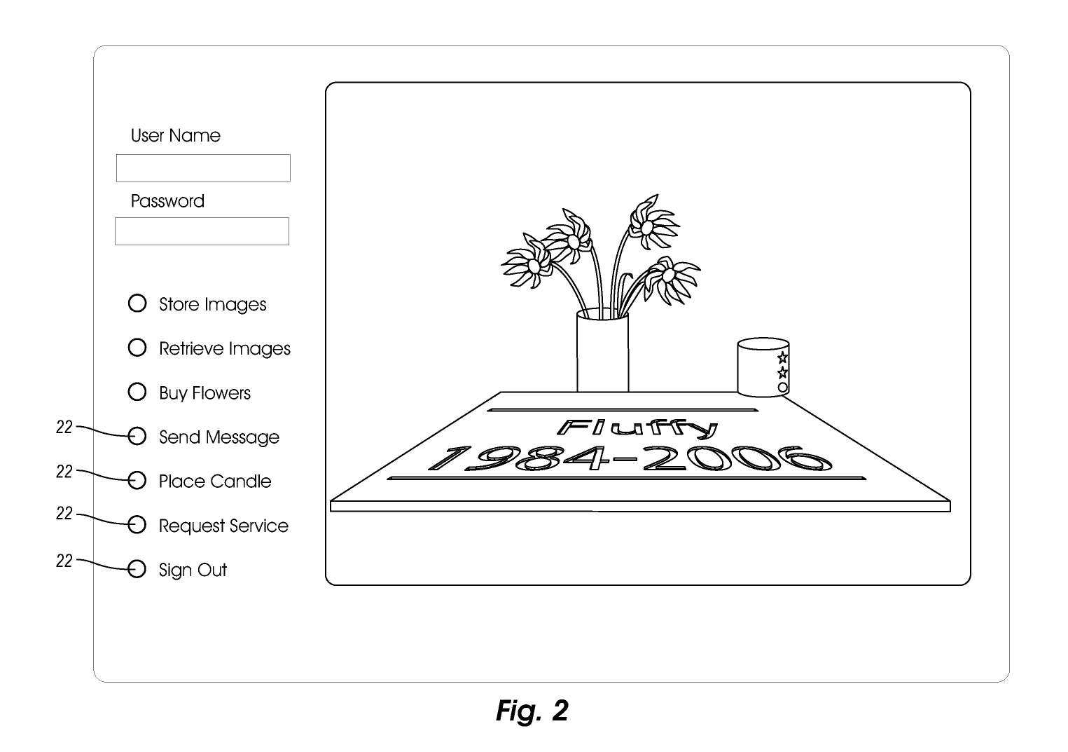

The display of the particular item is shown through a designated graphical user interface (GUI) such as the one shown in FIG. 2. While FIG. 2 shows one particular demonstration of a graphic user interface, it is to be distinctly understood that the invention is not limited to the particular GUI 20 which is shown in this figure, but that this configuration may be variously embodied to include a variety of other features and to include a variety of other formats as well. The GUI 20 provides a display that includes an image of the particular gravesite that is connected to the username and password. In addition a variety of other prompts 22 for additional actions such as store images, retrieve images, buy flowers, send messages, place candles, request service, log out of the service or other options may also be made available to a user. The listing of the aforementioned options is merely intended to illustrate the potential uses of the present invention and should not be construed as a limitation on the device itself.

In the preferred embodiment of the invention, the physical location of each individual plot, gravesite, tree, or urn within the memorial is a sign of a particular identifier. In this embodiment of the invention, the particular identifier is connected to a physical location on a map, which is serviced by a particular camera. The identifier and the map are input into the host control device is input into the host computer and a user name and password is connected with this identifier. In the simplest embodiment of the invention, the input of a designated user name and password into the host system triggers the command hierarchy to display an image from the plot, which is linked to this username and password, by means of the identifier. In more complex embodiments of the invention various modifications to this basic simple design may be had.

In various other embodiments of the invention, the display from the viewing device 12 is shown through a graphical user interface such as the graphical user interface which is shown in FIG. 2 of the present invention. It is of course, to be understood, that the example graphic user interface which is shown in FIG. 2 is merely intended for illustrative purposes and should not be considered limiting in any way to the scope of the application. This graphical user interface, in addition to showing a desired view of the particular plot, may also provide the user with a variety of other options. This may be dependent upon the system that has been set up by the business owner and the level of complexity of the equipment and tools, which are at the disposal of the parties.

In one embodiment of the invention, the user may have capabilities to control the camera from a remote location. This would enable them to scroll around the designated area so as to be able to view a variety of neighboring sites, the sky, or other items which are in the potential view of the remote camera. In other embodiments of the invention, links may be provided to enable the user, from this singular graphical user interface to the other locations. For example, through such an embodiment a party may be able to view three separate plots in three separate cemeteries located in three separate states or potentially three separate countries. In each of these embodiments, according to the set up which is available at the individual cemeteries parties would be able to, as has been discussed previously, move the video cameras to pan to a variety of other location.

In addition, some embodiments of the invention may also allow a user to store images from a particular day within a database which can then be accessed as needed in order to retrieve, modify or delete these images. In other embodiments of the invention the graphical user interface may also provide links for a variety of services related to the appropriate subject matter in which the device is displayed. These include potentials such as utilizing the graphical user interface to send flowers, messages of condolences, arrange for placement of candles upon the gravesite, arrange for landscaping from the caregivers at the cemetery, or any of a variety of other actions as well.

The input related to the purchase of these services takes place through the host computer 14. This host computer is preferably appropriately equipped and adapted to receive information through a transport media either directly or remotely. The particular technology through which this may be accomplished may be varied according to the particular needs and necessities of a person of skill in the art.

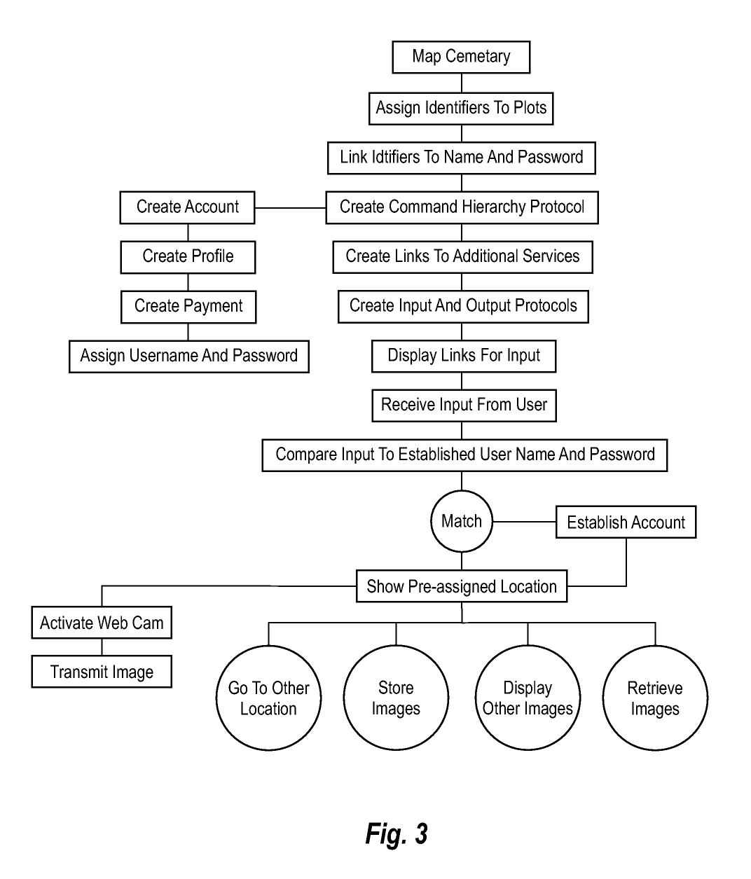

The present invention as shown in FIG. 3 includes a variety of steps, which are utilized in the creation, operation and maintenance of this system. In the first embodiment of the invention the system is set up by mapping the area and assigning each of the plots or subareas with a particular identifier. These identifiers are then linked to the user name and password in the hierarchy which has the ability to control at least one if not a plurality of video cameras to ensure the proper coverage of all of the requisite portions of the cemetery is obtained. The input of the user name and password creates a home which designates a particular location to which a particular camera will always be directed when the home portion is selected by the user. Depending upon other embodiments of the invention and various links, scrolling abilities, transmissions, image storage, image access and other features may also be accomplished.

In the event that a party logs onto the system and does not have a user name or password, a general screen may be displayed. In this display, the party will be offered the ability to create an account and an account profile, that will allow them to view the various portions of the cemetery. In addition to these particular features, various other combinations and modifications to this invention may also be obtained according to the needs and necessities of the user.

It is to be distinctly understood that while the present invention is described in the context of the cemetery that the application and obviously the present invention is not limited thereto. Or it may be used in any one of a variety of other types of circumstances and situations wherein a particular personalized item lodged within a plurality of other personalized items and designated location.

The present invention as set forth in the embodiments shown in the figures and described above illustrate but do not limit the invention. It should be understood that there is no intention to limit the invention to the specific form disclosed; rather, the invention is to cover all modifications, alternative constructions, and equivalents falling within the spirit and scope of the invention as defined in the following claims.

What is claimed is:

1. A system for allowing remote viewing of a particularized item located within a plurality of items; said system comprising:
at least one viewing device, said viewing device capable of viewing a designated location when activated by a host control device and transmitting a signal carrying an image of said designated location to a pre-selected remote destination; said host control device operatively connected to said viewing device so as to activate said viewing device when preselected conditions exist.

2. The system of claim 1 wherein said viewing device is a remote operated web cam positioned in a designated location, said remote operated web cam capable of being moved into and out of a variety of positions so as to allow selected individualized viewing of a particularized item within said plurality of items; said remote operated web camera operatively connected to said host device.

3. The system of claim 2 wherein said host device is configured to receive input from a source through a input transfer media and to direct movements of said remote operated web camera based upon a preselected program.

4. The system of claim 1 wherein said preselected conditions include the entering of an appropriate password which is operatively linked with a command hierarchy within said host control device which directs said viewing device to transmit a signal from a preselected location.

5. The system of claim 1 wherein said preselected conditions include the entering of an appropriate password which is operatively linked to a command hierarchy.

6. The system of claim 1 wherein said viewing device is positioned within a cemetery and wherein accessing said system by in putting an identifying password into said host control device causes said viewing device to display a particular gravesite within said cemetery.

7. The system of claim 1 wherein said host controller provides access to an authorized user to control said viewing device so as to scroll through a designated area.

8. The system of claim 1 wherein said host controller prevents viewing of particular portions of said designated area without compliance with a designated authorization code.

9. The system of claim 1 wherein said host controller is operatively connected to a website, that also provides links for the purchase of additional ancillary services.

10. A system for allowing remote viewing of a particularized gravesite location within a memorial cemetery; said system comprising:
at least one remote operated web cam positioned in a designated location, said remote operated web cam capable of being moved into and out of a variety of positions so as to allow selected individualized viewing of a particular gravesite location, said remote operated web camera operatively connected to a host device;
said host input device configured to receive input from a source through an input transfer medium and to direct movements of said remote operated web camera based upon a compliance with a preselected program;
said preselected program including the presentation of a preselected authorization code to said host controller;
said host controller capable of controlling the transmission of images by said remote operated web cam in accordance with a preselected command hierarchy.

11. In a system for allowing remote viewing of a particularized gravesite location within a memorial cemetery; said system including at least one remote operated web cam positioned in a designated location, said remote operated web cam capable of being moved into and out of a variety of positions so as to allow selected individualized viewing of a particular gravesite location, said remote operated web camera operatively connected to a host device, said host input device configured to receive input from a source through an input transfer medium and to direct movements of said remote operated web camera based upon a compliance with a preselected program, said preselected program including the presentation of a preselected authorization code to said host controller, said host controller capable of controlling the transmission of images by said remote operated web cam in accordance with a preselected command hierarchy, a method for providing memorial services, said method comprising the steps of:
mapping a cemetery or memorial area so as to provide a map of particularized plots;
assigning each of said particularized plots with a particular identifier;
linking each of said particular identifiers with a user name and password;
creating a command hierarchy wherein a user name and password is received through an inputting media;
matching said user name and password to a particular identifier;
commanding said remote operated web cam to present an image of the particularized plot that is assigned to the particular identifier that matches the user name and password;
transmitting said image from said remote operated web cam through an Internet communication media.

12. The method of claim 11 wherein the method of providing memorial services further comprises the steps of:
providing an interface wherein parties may purchase additional services for said graveside such as flower delivery, landscaping, message delivery, and candle placement.

13. The method of claim 11 further comprising the steps of:
providing access to remote viewing of other locations in side or outside of said cemetery.

14. The method of claim 11 further comprising the step of:
changing passwords based upon a preselected criteria.

15. The method of claim 11 further comprising the steps of:
capturing an image on a particular date and time;
storing said image in a designated location;
allowing access to said stored image upon the providing of an appropriate name and password by a user.
